(19) United States
(12) Patent Application Publication
(10) Pub. No.: US 2011/0311721 A1
(43) Pub. Date: Dec. 22, 2011

(54) Low temperature cure clear powder coating over liquid paint on heat sensitive substrates

(76) Inventor: Robert Langlois, Vaughan (CA)

(21) Appl. No.: 12/801,617

(22) Filed: Jun. 17, 2010

(51) Int. Cl. B05D 3/10

(52) U.S. Cl. 427/195

(57) ABSTRACT

A method of applying a clear thermo set powder coating(s) to non-conductive heat sensitive plastic substrates having been previously liquid painted with an adhesion promoter and/or primer/basecoat or basecoat or any combination therein. The method allows for the application of a decorative or functional clear powder coated surface to a previously liquid painted heat sensitive non-conductive substrate. The application can be in a variety of gloss levels, metallic flake or texture.

### FIELD OF THE INVENTION

The present invention relates to a method of applying a clear thermo set powder coating(s) to non-conductive heat sensitive plastic substrates having been previously liquid painted with an adhesion promoter and/or primer/basecoat or basecoat or any combination therein. The heat sensitive substrates may include but not be limited to, TPO (Thermoplastic Olefin), TPE (Thermoplastic Elastomer), PP (Polypropylene) and PCABS (Polycarbonate Acrylonitrile Butadiene Styrene) materials and other non-conductive plastic substrates.

### BACKGROUND OF THE INVENTION

Industries such as the automotive industry are striving to look for materials that can increase performance, reduce costs, while providing a lower carbon footprint and or a green alternative to existing materials and processes. In general liquid paints emit significant VOCÑ (Volatile Organic Compounds), isocyanates and HAPÑ (Hazardous Air Pollutants) as well as have a poor transfer efficiencies compared to powder painting. Powder applications allow for the reclaim of painting over-spray, whereas liquid applications require expensive and complex systems to collect the over-spray liquids, which cannot be reused and must be managed as a toxic by product. Complex and expensive systems must be employed to deal with the fumes containing VOCÑ and HAPÑ, which are generated during the painting process. Often these air-handling systems require costly equipment called RTOÑ (Regenerative Thermal Oxidizer), which generates sufficient heat through the burning of Natural Gas or other similar fuels to incinerate the VOCÑ and HAPÑ. Powder does not require such elaborate air handling systems as there are no VOC or HAP emissions during the application or curing process, thus significantly reducing energy consumption and the creation of green house gases.

Currently, heat sensitive materials primarily being TPOÑ, are what would be typically used on an automotive bumper or fascia are being liquid painted. In most situations the process involves, an adhesion promoter, a primer, two applications of base coat and a further two applications of a clear coat. However, with the introduction of low cure powder paint technologies, such as those commercially available by Akzo Nobel, low temperature Acrylics, Polyamides and Polyesters, the opportunity now exists to substitute the liquid topcoat (clear coat) with a low temperature cure thermo set powder clear coat over the liquid base coat(s).

The present invention has eliminated the environmental emissions associated with liquid clear coats, has reduced the production costs, and provides superior aesthetics and performance over that of the substituted liquid clear coat. It finds application in the automotive, plumbing, recreational, appliance, hardware and electronics industries.

### DESCRIPTION OF THE PRIOR ART

U.S. Pat. No. 5,565,240 which issued Oct. 15, 1996 and U.S. Pat. No. 5,344,672 issued Sep. 6, 1994 to Smith, discloses a process for producing powder coated parts in which the preferred embodiment uses a water-based electrically conductive coating which is cured while the substrate is heated to degas with the subsequent application of powder at a temperature below the cure temperature. Firstly, the Smith invention relies on a water-based conductive coating, whereas the object of this invention is not to rely on pre-treatment process. Secondly, Smith does not apply any functional primers, liquid base or mid coats which would subsequently be followed by a single or multiple layers of powder clear coats.

U.S. Pat. no. 6,458,250 which issued Oct. 1, 2002 to Holliday, discloses a pre-treatment process for the application of powder coating to a non-conductive substrate by first exposing the non conductive substrate to a combination of steam and heat. Firstly, Holliday relies on steam and heat to provide for a conductive surface, whereby the object of this invention is not to rely on any steam and does not require the substrate to be conductive or require any conductive pre-treatment prior to the application of the powder top coat. Secondly, the Holliday invention is for the application of powder as the sole finish coat, preferably on wood, MDF and as a mono-coat, whereby the object of this invention is to provide a mono-coat or multiplayer low cure powder clear coat over an existing liquid primer/base-coat or basecoat.

U.S. Pat. No. 6,620,463, which issued on Sep. 16, 2003 and U.S. Pat. No. 6,855,429, which issued Feb. 15, 2005 to Stay, discloses processes for applying a surface treatment to induce conductivity. Firstly, Stay requires that the substrates be exposed to a surface treatment composition, which induces conductivity, whereas the object of this invention does not require such conductivity treatment. Secondly, Stay does not introduce combinations of multi-layer paint applications, whereas the object of this invention is to provide a automotive Class ÈA\check{S} finish comprising of a combination of liquid primer and or liquid base coats followed by a low temperature cure powder clear coat or coats over the liquid painted substrate.

U.S. Pat. No. 5,338,578, which issued in August 1994 to Leach, describes a process for a low-density compression-molded plastic article. Firstly, the Leach invention is specifically for compression-molded parts, whereas the object of this invention is for injection-molded substrates in addition to all other manufactured non-conductive substrates. Secondly, the leach invention is for material having a specific gravity of less than 1.4, whereas this invention is primarily for materials of any specific gravity. Thirdly, the Leach invention includes that the part contain hollow unicellular glass micro-spheres, whereas the object of this invention is to be able to coat all heat sensitive non-conductive substrates. Fourthly, the Leach invention requires that the first paint layer to be a powder and subsequent paint layers are powder electrostatically applied, whereas the object of this invention is a multi-layer application of liquid primers and or liquid basecoats or combinations therein, with a final powder low cure top coat, or top coats.

U.S. Pat. No. 5,624,735 issued in April, 1997 and U.S. Pat. No. 5,516,551 issued in May 1996 to Anderson provides a process to seal the edges of sheet molded compounds (SMC) for the purposes of providing a smooth edge for further processing to provide a wet painted decorative surface. The application of powder materials in the Anderson invention is done by electrostatic spray. Firstly, the Anderson invention is intended for SMC materials, whereas this invention is for all non-conductive heat sensitive substrates, with the preferred substrate being injection molded materials such as TPO. Secondly, the Anderson invention is for the priming or preparation of surface edges for later application of a liquid paint finish, whereas the object of this invention is to provide a clear coat powder finish coat over a liquid painted substrate.

U.S. Pat. No. 5,021,297 issued Jun. 4, 1991 to Rhue discloses a process of coating substrates susceptible to gassing with a powder coating composition. Firstly, the Rhue invention is intended for fibre-reinforced plastics susceptible for gassing, whereas the preferred embodiment of this invention is for non-fibre re-enforced substrates, such as TPO. Secondly, the Rhue invention requires the degassing of the substrate above the cure temperature of the powder, whereas the object of this invention is to apply the low cure powder coat over the liquid base coat at below the cure temperature of the thermo set powder, with no requirement for degassing the substrate prior to application of the powder. Thirdly, the Rhue invention is for the application of high temperature powders to high temperature substrates, such as SMC and BMC substrates, whereas the object of this invention if for heat sensitive substrates such as TPO, that would melt and liquefy at such temperatures, to be painted with a low cure clear powder coat subsequent to the prior application of one or several liquid paint applications.

U.S. Pat. No. 6,342,273, which issued Jan. 29, 2002 to Handles, discloses a process for coating a substrate with a powder composition. Firstly, the Handles invention relies on a carrier or transfer medium to carry the powder particles to the substrate surface, whereby the powder paint particles are first charged by friction or induction in the presence of magnetic or nonmagnetic particles, whereas the object of this invention is to not rely on a conductive or charged transfer media to facility the application of powder paint to the substrate. Secondly the Handle invention deals solely with powder application, whereas the object of this invention is to paint a heat sensitive substrate such as TPO with a layer(s) of liquid paint followed by a low cure powder clear coat.

U.S. Pat. No. 6,214,421 granted to Pidzarko relies on the application of super saturated steam moisture to the substrate to achieve adherence to the substrate. The object of this invention is to not use any moisture. By adding moisture to the process, this will increase the process times, lead to potential gassing issues as plastic or other non conductive substrates could absorb moisture below the surface and when cured, will cause severe surface blemishes, and lastly could affect the performance of the powder coatings, by there nature are dry and meant to be applied in a dry environment.

U.S. Pat. No. 6,921,558, which issued Jul. 26, 2005 to Fredericksen, discloses a method for powder coating articles includes the steps of preheating the article to a preheating temperature, coating the article with a polymeric powder coating having a cross-linking temperature that is above the preheating temperature and curing. Firstly, The Fredericksen invention requires a cure temperature of at least 375.Degree.F., whereas the object of this invention is to have a significantly lower cure temperature for such materials as TPO, which substrate would otherwise liquefy under the Fredericksen cure temperature. Secondly the Fredericksen invention relies on preheat to degas the substrate whereas the object of this invention is to cure and coat substrates with no such concern. Thirdly, the object of this invention is to provide a powder clear coat over a liquid basecoat or liquid primer/basecoat which does not rely on the preheating of the substrate but utilizes the resident core temperature of the substrate incurred during the cure of the liquid paint applications. Concerns with Fredericksen is that the part must be preheated to above the cross linking temperature is above the preheat temperature, wherein, the object of this invention is to allow for the application of powder on temperatures above the cross linking temperature which allows for greater transfer efficiency and a higher peel rating or a smoother part. Most importantly the Fredericksen invention does not include the application of powder over a liquid base coat(s), but is solely meant for mono or multi-layers of powders.

U.S. Pat. No. 6,296,939 which issued Oct. 2, 2001 to Kunze which discloses a process for preferably wood, and a powder paint coat applied therein, by applying at least one coat of water based liquid paint, heating the substrate by microwave irradiation, the hardening of the coating and the subsequent application of powder paint to the substrate. Kunze relies on Microwave irradiation, wherein the object of this invention does not. Kunze invention relies on the powder compositions to be epoxy and polyesters, wherein in the preferred method of this invention, Acrylic Clear coats are used. The Kunze invention relies on a water-based liquid base coat that must be hardened by ultraviolet radiation and is designed to be a functional coating for the further application of powder, wherein the object of this invention is the application of a low temperature powder clear coat over a aesthetic or decorative liquid water-based or solvent borne liquid paint which would commonly be used for automotive applications. The object of this invention is the replacement of liquid clear coat technology with powder clear coat technology by retrofitting current commercial paint lines. The concerns with Kunze are that the powders are very limited, epoxy based, which do not allow for aesthetics and exterior performance required by such industries as automotive, the preferred method is for wood, requires the substrate to be heated by microwave irradiation all of which are not conducive to the application of a clear coat powder over a liquid metallic basecoat.

U.S. Pat. No. 6,319,562, which issued Nov. 20, 2001, and 6,592,665, which issued Jul. 15, 2003 to Arverus, describes a method for powder coating with a powder having a melting and softening temperature of below 100.degree.C. The said powder to be used must be curable under the influence of electromagnetic radiation. Wherein the object of this invention, is the application of a low temperature powder clear over a liquid base coat wherein the said powder in the preferred method is cured in a traditional convection oven.

### SUMMARY OF THE INVENTION

It is therefore an object of the present invention to provide a process, which allows for the application of a decorative or functional clear powder coated surface to a previously liquid painted heat sensitive non-conductive substrate. The application of a clear powder clear coat(s) in can be in variety of gloss levels, metallic flake or texture.

A further object of this invention is to provide an apparatus for a process, which can be integrated into an existing liquid paint facility.

A further object of this invention is to provide an apparatus and a process for a Greenfield manufacturing paint facility.

A still further object of this invention is to provide a process for the application of a clear powder paint over a liquid basecoat or over a liquid primer/basecoat to a non-conductive heat sensitive substrate such as TPO without the need for conductive liquid paints, conductive impregnated substrates thus reducing the costs and increasing the efficiencies of the process.

A still further object of this invention is to provide a process for the application of multiple powder clear coat applications over a liquid base coat wherein one of the base coats may contain special effect pigments such as a metallic.

It is yet a further object of this invention is to provide a suitable painting process to eliminate or replace existing liquid paint processes which use paints, primers and which emit VOCÑ (Volatile Organic Compounds) and contain HAPÑ (Hazardous Air Pollutants).

A still further object of this invention is to provide a cost effective method of applying a decorative or functional painted surface to plastic or non-conductive substrates.

It is a further object of this invention to provide a process, which has eliminated the need for use of conductive primers prior to the application of a clear powder coat over liquid.

A further object of this invention is to reduce the overall steps required to provide a first class finish to a non-conductive substrate.

It is still an object of this invention is to provide an inline; enclosed environmentally controlled apparatus which reduces or eliminates airborne contamination which is associated with traditional powder coating apparatus.

### BRIEF DESCRIPTION OF THE DRAWINGS

FIG. 1 illustrates in schematic form an apparatus designed to carry out the process and the method of the present invention.

### DETAILED DESCRIPTION OF THE PREFERRED EMBODIMENT

The drawings show a process and apparatus for the application of thermosetting powders to non-conductive substrates by means of an inline coating system which controls the environment inside the apparatus to form ideal coating conditions while maintaining the substrate temperature at levels necessary for the application of thermosetting powders. The substrates may be, but not limited to PA (Nylon), PC (Polycarbonates), TPO (Thermoplastic Olefins), PET (Polyethylene Terephthalate), RIM (Reaction Injection Molded), PCABS (Polycarbonate Acrylonitrile Butadiene Styrene) and ABS (Acrylonitrile Butadiene Styrene) materials.

The apparatus and process allow for a single or multiple layer of thermosetting low temperature clear powder(s) to be applied.

The powder technology is, but not limited to, an acrylic based technology such as Akzo Nobel low temperature acrylic clear coat technology, CZ006D. Other powder technologies may include but not limited to Polyesters and Polyamides.

The application of the powder clear coat is over a liquid base coat, which may or may not include the prior application of a liquid primer.

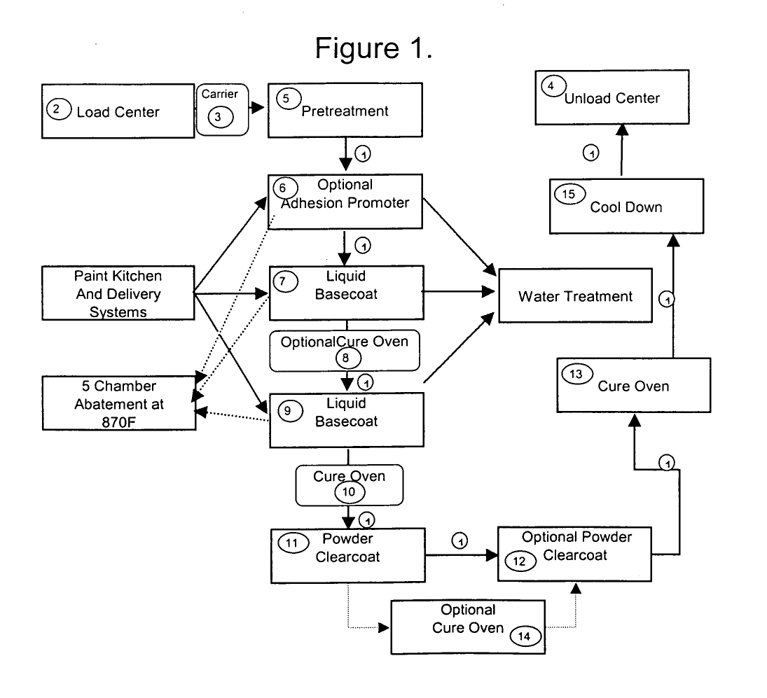

FIG. 1. shows in schematic form a machine designed to carry out the process or method of this invention:

The machine has a continuous conveyor 1 which has both an infeed or load area 2 for the purposes of placing substrates on carriers 3 to be moved through the process via the conveyor 1.

There is an outfeed or un-racking area 4 designed for the purposes of removing the completed substrates from the carriers to prepare for the next batch of substrates to be racked in area 2.

The process is a continuous conveyor system 1 where the substrates enter a spray wash and rinse booth 5 where the substrates are washed and rinsed with water and subsequently dried to remove any excess rinse materials via a warm air blower system.

The substrates travel via the continuous conveyer 1 to the next station 6 where the substrates may receive an optional application of a water based or solvent based primer(s) and or adhesion promoter. The substrates once having the optional adhesion promoter layer applied will immediately move via the continuous conveyor 1 to the liquid paint booth 7 in which the substrates will receive an application of paint, not limited to, water based or solvent based liquid, comprising a 1 component or two component paint technology

The substrates will travel via the continuous conveyer 1 to a cure oven 8 whereby the liquid paint shall optionally be cured, via a cure system, not limited to, IR or Convection heating at a temperature sufficient to cure fully or partially the first liquid layer.

Optionally the first base coat application in booth 7 may travel via the continuous conveyor and not be cured in oven 8, whereby the second application of liquid may be applied in liquid basecoat booth 9.

Optionally the substrate may receive only one coat of liquid base coat in either liquid booth 7 or liquid booth 9 and optionally be cured in either oven 8 or oven 10.

Upon exiting the bake oven 10, the substrates move via the continuous conveyor 1 shall enter the powder clear coat booth 11 for an application of powder via, but not limited to, robotic application, manual application while the temperature of the part is less than the melting temperature of the substrate. Temperatures are, but not limited to, typically less than 325.degree.F. and more than 125.degree.F.

Optionally the substrate may exit either liquid booth 7, liquid booth 9 via the continuous conveyor 1 and bypass either cure oven 9 or cure oven 10 and via the continuous conveyor powder clear coat booth 11 or powder clear coat booth 12.

Optionally prior to the entry of the substrate via the continuous conveyor to powder booth 11, the substrate may be subjected to additional IR or convection heating to ensure the substrate core temperature of the substrate is maintained.

Optionally the application of the clear coat powder in powder booth 11, may include special effect additives, not limited to metallic.

The substrates move via the continuous conveyer 1 and optionally enter powder booth 12 for the purposes of powder coating application. The optional application of powder may be, but not limited to, a clear coat in which the optional application of special effects deposited in powder booth 11 is top coated.

Once the substrates have been powder coated, optionally in powder booth 11, or in both powder booths 11 and 12 or solely in powder booth 12, they travel via the continuous conveyor system 11 to cure oven 13 which is a curing oven employing any combination or solely of IR and or convection, gas or electric to cure the substrate at a temperature and for a duration sufficient to fully cure the powder coat(s) and or the combination of liquid base coats and the powder coats received in combination of paint booths, 7,9,11,12.

The substrates travelling via the overhead or inverted continuous conveyor 1 through a cooling zone 15, whereby the substrates will move to un-racking area 4.

The present invention may be used with any suitable plastic or non-conductive substrate. Examples of such substrates include ABS resins such as those commercially available from The Dow Chemical Company under the trade name MAGNUS 1040, MAGNUM 1150EM, MAGNUM 3404 and MAGNUS 344 H.P. Examples of other material substrates such as those commercially available from Bayer Polymers include Makrolon (Polycarbonate), Bayblend (Polycarbonate/ABS Blend), Makroblend (Polycarbonate/Polyester Blend), Durathane (Polyamide 6 and 66 and Amorphous Polyamide), Cadon (SMA), Lustran (SAN), Texin (Thermoplastic Polyuerethane, Baydur (Structural Foam) and Prism (solid Polyurethane RIM Systems).

In summary, the present method allows for a smaller apparatus, increased efficiency a reduction energy consumption with an associated lower carbon footprint while providing a superior thermosetting powder coated clear coat over liquid on a heat sensitive non conductive substrate. With the substitution of a powder clear coat from a liquid clear coat, the powder application does not require, any water treatment and water collection system 14, and does not require any VOC or HAPÑ abatement systems 16.

While the present invention describes and discloses the preferred embodiment, it is understood that the present invention is not so restricted.

1. A method for applying a clear thermo set powder coating a non-conductive plastic substrate over an existing liquid painted layer(s) comprising the following steps:
(a) cleaning said substrates to remove any contaminants, dirt or mold release agents there from with known art;
(b) optionally applying a liquid adhesion promoter to substrate, known art;
(c) optionally applying a liquid primer coat, known art;
(d) optionally curing the liquid primer utilizing known art;
(e) application of a liquid base coat utilizing known art;
(f) optional application of a second layer of liquid base coat utilizing known art;
(g) optionally curing the liquid base coat(s) utilizing known art;
(h) applying a thermosetting clear powder to the substrate upon exit of the liquid cure oven;
(i) Optionally applying a thermosetting clear powder to the substrate upon exiting the liquid paint booth;
(j) Optionally applying a second powder clear coat to the substrate upon exiting the first powder clear booth;
(k) curing said thermosetting powder with IR or convection heat.

2. A process as claimed in claim 1 where the application of the thermo set powder is capable of being cured at a temperature below 325.Degree.F. so as to not degrade the substrate or the prior application(s) of liquid base coats, primers and adhesion promoters.

3. A process as claimed in claim 2 where the low temperature cure clear powder coating thermo set resin is curable at a temperature of less than 325.Degree.F. and preferably at a temperature of 250.Degree.F. for a sufficient time to fully cure.

4. A process as claimed in claim 3 which utilizes, but not limited to, a clear acrylic powder, such as supplied by Akzo Nobel CN006D, defined as a low cure powder technology capable of curing at less than 325.Degrees.F. and more specifically at 250. Degrees.F.

5. A process as claimed in claim 1 whereby a single application of liquid basecoat is cured at a sufficient temperature prior to the application of powder.

6. A process as claimed in claim 5 where the application of the powder coat is applied directly upon exit of the liquid cure oven without the requirement for a cool down period.

7. A process as claimed in claim 6 whereby the application of the powder coat may be applied at a substrate temperature of less than 325.Degree.F.

8. A process in claim 1 where a single application of liquid basecoat is applied with a subsequent application of a powder clear coat.

9. A process as claimed in claim 8 where the liquid paint does not have to be cured prior to the application of the powder clear coat.

10. A process as claimed in claim 8 where a second application of powder is applied.

11. A process in claim 1 whereby two applications of liquid base coat are applied to the substrate and subsequently cured with a further application(s) of powder clear coat.

12. A process in claim 1 whereby the application(s) of liquid basecoat and powder clear coat(s) are co-cured.

13. A process in claim 12 whereby the application(s) of liquid basecoats are partially cured prior to the application of the powder clear coat(s) then subsequently fully cured through a co-cure in the powder cure oven.

14. A process as claimed in claim 1 wherein said non-conductive heat sensitive plastic substrate is, but not limited to, to a TPO (Thermoplastic Olefin).

15. A process as claimed in claim 1 wherein said substrate is moved through the sequence series of steps by the use of a continuous conveyor.

16. A process as claimed in claim 1 wherein said substrate is cleaned in a cleaning booth which spray rinses said substrates and then blow dries said substrates with warm air or utilizes other know art such as plasma treating.

17. A process as claimed in claim 1 wherein said optional adhesion promoter is spray coated to said substrate.

18. A process as claimed in claim 1 wherein said adhesion promoter is cured using known art at temperature and for a time sufficient for the adhesion promoter to cure.

19. A process as claimed in claim 1 wherein said thermosetting powder is cured in a curing oven employing singularly or in combination infrared or convection, gas or electric heating system.

20. A process in claim 1 where the first powder coat application is fully cured prior to the application of the second powder coat.

21. A process in claim 1 where the first powder coat is partially cured prior to the application of the second powder coat.

22. A process in claim 21 where the first powder coat is partially cured using IR, or convection or a combination therein.

23. A process in claim 1 where the second powder coat is co-cured with the first application of powder coat.

24. A process in claim 1 whereby the liquid base coats are known art, which may be water based or solvent based. Either the water based or the solvent based products can be 1k (one component) or 2k(two component) systems

25. A process as claim 1 whereby the first application of powder clear coat may incorporate special effect additives such as metallic.

26. A process as claim 25 in which the first application of powder clear coat with special effects is powder coated with a clear coat with no special effect additives that can act as a barrier.

27. A process as in claim 26 in which the second application of powder clear over the first application of powder clear with effect additives will increase the gloss level.
